(19) United States
(12) Patent Application Publication
(10) Pub. No.: US 2014/0046879 A1
(43) Pub. Date: Feb. 13, 2014

(54) MACHINE LEARNING SEMANTIC MODEL

(71) Applicant: Predixion Software, Inc., San Juan Capistrano, CA (US)

(72) Inventors: C. James MACLENNAN, Redmond, WA (US); Ioan Bogdan CRIVAT, Woodinville, WA (US)

(73) Assignee: Predixion Software, Inc., San Juan Capistrano, CA (US)

(21) Appl. No.: 13/966,223

(22) Filed: Aug. 13, 2013

Related U.S. Application Data
(60) Provisional application No. 61/682,716, filed on Aug. 13, 2012.

(51) Int. Cl. G06N 99/00

(52) U.S. Cl. CPC G06N 99/005
USPC 706/12

(57) ABSTRACT

The subject technology discloses configurations for creating reusable predictive models for applying to one or more data sources. The subject technology specifies a business problem to determine a probability of an event occurring. The business problem may include a constraint. A data source is selected for a predictive model associated with a predictive algorithm in which the predictive model includes one or more queries and parameters. A set of transformations are then determined based on the queries and parameters for at least a subset of data from the data source to be processed by the predictive algorithm. The subject technology identifies a set of patterns based on the set of transformations for at least the subset of data from the data source. A trained predictive model is then provided including the determined set of patterns, the set of transformations, and the associated predictive algorithm for solving the specified business problem.

### CROSS-REFERENCE TO RELATED APPLICATIONS

The present application claims the benefit of priority under 35 U.S.C. §119 from U.S. Provisional Patent Application Ser. No. 61/682,716 entitled “MACHINE LEARNING SEMANTICS MODEL,” filed on Aug. 13, 2012, the disclosure of which is hereby incorporated by reference in its entirety for all purposes.

### BACKGROUND

The present disclosure generally relates to predictive analytics that may utilize statistical techniques such as modeling, machine learning, data mining and other techniques for analyzing data to make predictions about future events. For example, predictive analytics may be used in a variety of disciplines such as actuarial science, marketing, financial services, insurance, telecommunications, retail, travel, healthcare, pharmaceuticals and other fields.

### SUMMARY

The subject technology provides for a computer-implemented method, the method including: specifying a business problem to determine a probability of an event occurring in which the business problem includes a constraint; selecting a data source for a predictive model associated with a predictive algorithm in which the predictive model includes one or more queries and parameters; determining a set of transformations based on the queries and parameters for at least a subset of data from the data source to be processed by the predictive algorithm; identifying a set of patterns based on the set of transformations for at least the subset of data from the data source; and providing a trained predictive model including the determined set of patterns, the set of transformations, and the associated predictive algorithm for solving the specified business problem.

The subject technology provides for a computer-implemented method, the method including: selecting a data source for a trained predictive model in which the trained predictive model includes a set of patterns, a set of transformations, and is associated with a predictive algorithm for solving a business problem; applying the set of patterns according to the predictive algorithm to return a set of data from the data source; performing the set of transformations on the set of data; and providing a score indicating a probability of an event specified by the business problem based on the predictive algorithm on the set of data.

The subject technology provides for a computer-implemented method, the method including: receiving a score corresponding to a predictive model for solving a business problem; converting the score into a semantically meaningful format for an end-user; and providing the converted score to the end-user.

Yet another aspect of the subject technology provides a system. The system includes one or more processors, and a memory including instructions stored therein, which when executed by the one or more processors, cause the processors to perform operations including: specifying a business problem to determine a probability of an event occurring in which the business problem includes a constraint; selecting a data source for a predictive model associated with a predictive algorithm in which the predictive model includes one or more queries and parameters; determining a set of transformations based on the queries and parameters for at least a subset of data from the data source to be processed by the predictive algorithm; identifying a set of patterns based on the set of transformations for at least the subset of data from the data source; and providing a trained predictive model including the determined set of patterns, the set of transformations, and the associated predictive algorithm for solving the specified business problem.

The subject technology further provides for a non-transitory machine-readable medium comprising instructions stored therein, which when executed by a machine, cause the machine to perform operations including: specifying a business problem to determine a probability of an event occurring in which the business problem includes a constraint; selecting a data source for a predictive model associated with a predictive algorithm in which the predictive model includes one or more queries and parameters; determining a set of transformations based on the queries and parameters for at least a subset of data from the data source to be processed by the predictive algorithm; identifying a set of patterns based on the set of transformations for at least the subset of data from the data source; and providing a trained predictive model including the determined set of patterns, the set of transformations, and the associated predictive algorithm for solving the specified business problem.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several configurations of the subject technology are set forth in the following figures.

FIG. 1 illustrates an example computing environment including a machine learning semantic model (MLSM) server according to some configurations of the subject technology.

FIG. 2 conceptually illustrates an example process for training a predictive model for solving a business problem according to some configurations of the subject technology.

FIG. 3 conceptually illustrates an example process for scoring a predictive model for solving a business problem according to some configurations of the subject technology.

FIG. 4 conceptually illustrates an example process for performing post-processing of an output from scoring a predictive model according to some configurations of the subject technology.

FIG. 5 conceptually illustrates an example communication flow from a client computing system to a machine learning semantic model (MLSM) server for pushing data to the MLSM server according to some configurations of the subject technology.

FIG. 6 illustrates an example graphical user interface (GUI) that may be provided by a spreadsheet application according to some configurations of the subject technology.

FIG. 7 illustrates an example GUI for accessing one or more data sources according to some configurations of the subject technology.

FIG. 8 illustrates an example GUI for selecting data in an column that includes encoded data according to some configurations of the subject technology.

FIG. 9 illustrates an example GUI for decoding encoded data according to some configurations of the subject technology.

FIG. 10 illustrates an example GUI for performing a business transformation on a column of data according to some configurations of the subject technology.

FIG. 11 illustrates an example GUI including a column with data that has a skewed distribution according to some configurations of the subject technology.

FIG. 12 illustrates an example GUI including a set of graphical controls for removing outliers in a set of data.

FIG. 13 illustrates an example GUI including a set of graphical controls for normalizing a given set of data according to some configurations of the subject technology.

FIG. 14 illustrates an example GUI including a set of graphical controls for binning a set of data according to some configurations of the subject technology.

FIG. 15 illustrates an example GUI for creating an application that represents a predictive model according to some configurations of the subject technology.

FIG. 16 illustrates an example GUI for specifying a goal of a predictive model according to some configurations of the subject technology.

FIG. 17 illustrates an example GUI for automatic selection of a best model based on a goal according to some configurations of the subject technology.

FIG. 18 illustrates an example GUI for providing a transformation pipeline in a query tool according to some configurations of the subject technology.

FIG. 19 illustrates an example GUI for applying a predictive model to new data according to some configurations of the subject technology.

FIG. 20 conceptually illustrates an example of an electronic system with which some configurations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

Predictive analytics may utilize statistical techniques such as modeling, machine learning, data mining and other techniques for analyzing data to make predictions about future events. For instance, predictive models may be utilized to identify patterns found in historical data, transactional data and other types of data to predict trends, behavior patterns, future events, etc. However, existing implementations of applying predictive modeling may not provide results in a manner that is easily interpreted and meaningful to an end-user. As a result, the end-user may have difficulty in understanding the results provided in such implementations. Existing predictive modeling implementations may neglect to consider restrictions specified in a given business problem resulting in a solution that is not relevant for the business problem. Further, predictive models that are provided for a particular enterprise may not support reutilization of predictive models for other data sets associated with other enterprises or end-users.

As described herein, a machine learning semantic model (MLSM) functions as a bridge from raw data to a predictive analytics solution and has the following properties:
Reusable—a MLSM is the definition and description of a machine learning problem. It specifies all necessary data transformations and operations independent of a specific data source. A MLSM can be productized as part of a solution for a particular business problem.
Relevant—a MLSM is defined and described with business operations in mind. Clear language is used to define components independent of what is required for a particular predictive algorithm. Output of predictive algorithms is restated into relevant business terms.
Accessible—a MLSM provides a mapping between source data, a business problem, and predictive algorithm requirements. Data can be presented to an MLSM in either raw or semantic representations. APIs can access all the details of a semantic model's mapping capabilities in order to present the most relevant view of the model to a user.
Data Source Independent—a MLSM is independent and separate of any particular data source. For instance, a MLSM can be created in a conventional spreadsheet application and later applied to data stored in a relational database.

In one example, a data set contains input data schema, and transformation operations to create a case set from a data source. A data set will typically be mapped to a data source, and can be remapped to an arbitrary data source. The data set will continue to contain all models that have been created on the case set (a “case”). A predictive model is contained by a data set. Thus, a predictive model is an instantiation of a MLSM against a particular predictive algorithm, and operates on cases created by the MLSM.

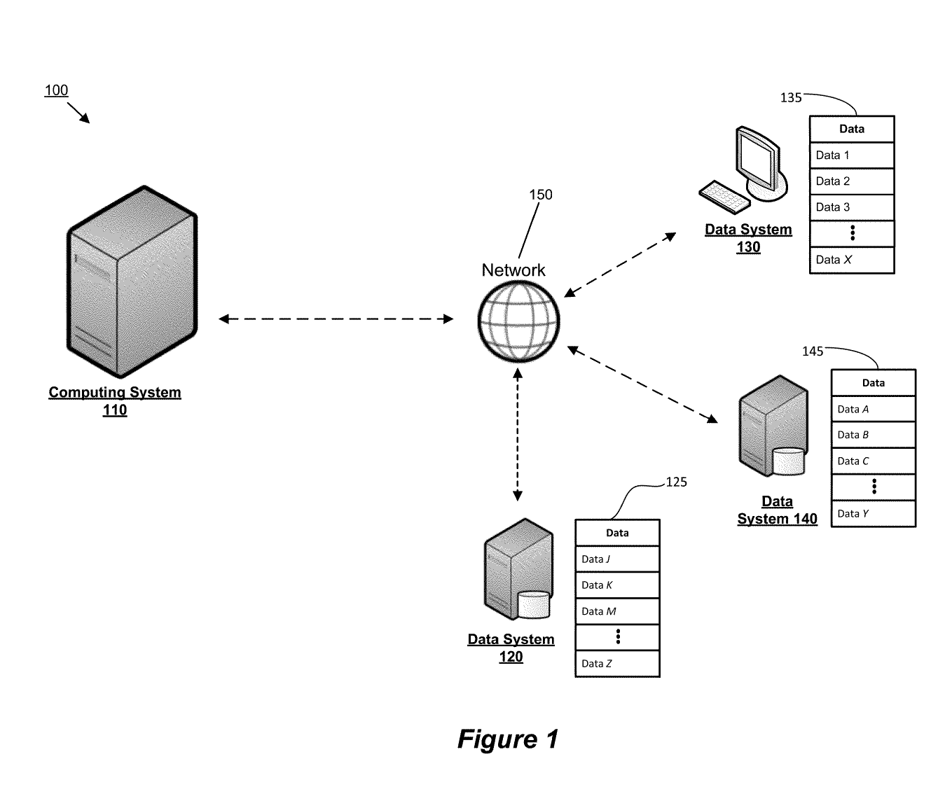

FIG. 1 illustrates an example computing environment 100 including a machine learning semantic model (MLSM) server. More specifically, the computing environment 100 includes a computing system 110 and data systems 120, 130 and 140.

In some configurations, the computing system 110 includes a machine learning semantic model (MLSM) server for applying predictive models on one or more data sources. One or more clients devices or systems may access the computing system 110 in order to generate predictive models for solving business problems on a data source(s).

As further illustrated in FIG. 1, the data systems 120, 130 and 140 are multiple autonomous data systems that respectively store data 125, data 135 and data 145. Some examples of data stored by a respective data system may include, but are not limited to, server-side data stored according to a relational database management system (RDBMS), data stored across a distributed system (e.g., NoSQL, HADOOP), or client-side data from an application, etc. A client data source may be provided as shown in data system 130 and/or in other data systems. For instance, data tables from a spreadsheet application(s), SQL Server Integration Services (SSIS), etc. Other types of data may be provided in a respective data system and still be within the scope of the subject technology.

As illustrated in the example of FIG. 1, the computing system 110 and the data systems 120, 130 and 140 are interconnected via a network 150. In one example, the computing system 110 utilizes an appropriate data connection(s) (e.g., Java Database Connectivity, Open Database Connectivity, etc.) for communicating with each of the data systems. Over one or more data connections, the computing system 110 can transmit and receive data via the network 150 to and from the data systems 120, 130 and 140. The network 150 can include, but is not limited to, a local network, remote network, or an interconnected network of networks (e.g., Internet). Similarly, the data systems 120, 130 and 140 may be configured to communicate over the network 150 with the computing system 110 by using any sort of network/communications/data protocol.

Although the example shown in FIG. 1 includes a single computing system 110, the computing system 110 can include a respective cluster of servers/computers that perform a same set of functions provided by the computing system 110 in a distributed and/or load balanced manner. A cluster can be understood as a group of servers/computers that are linked together to seamlessly perform the same set of functions, which can provide performance, reliability and availability advantages over a single server/computer architecture. Additionally, other data systems may be included in the example computing environment and still be within the scope of the subject technology.

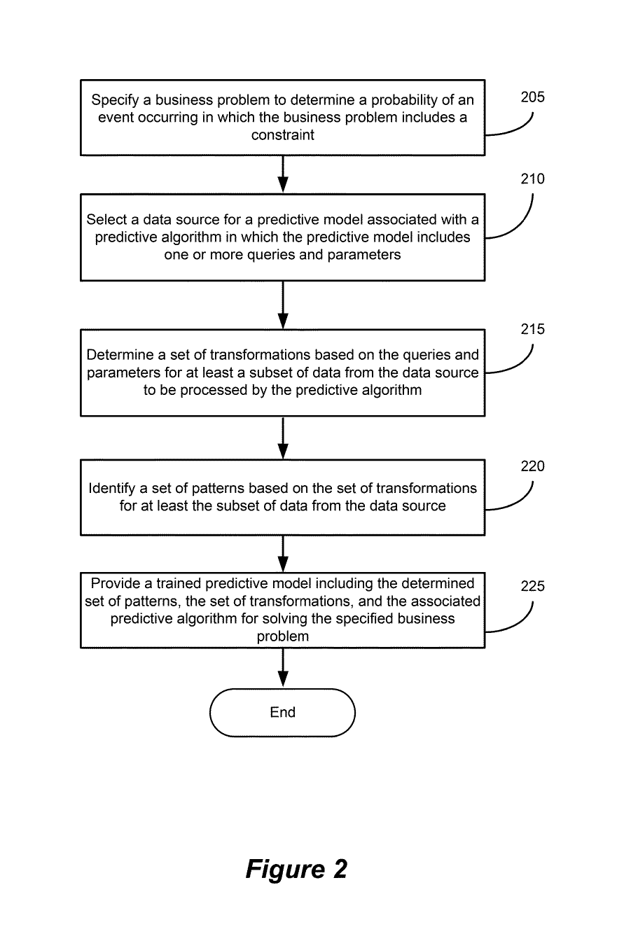

FIG. 2 conceptually illustrates an example process for training a predictive model for solving a business problem. The process in FIG. 2 may be performed by one or more computing devices or systems in some configurations. More specifically, the process in FIG. 2 may be implemented by the MLSM (machine learning semantic model) server in FIG. 1.

The process begins at 205 by specifying a business problem to determine a probability of an event occurring in which the business problem includes a constraint. The business problem may attempt to determine a likelihood of an occurrence of an event and the constraint may specify a set of conditions that have to be met for the event. For instance, the conditions may include a specified budget, a cost scenario, a ratio of a number of false positives and/or false negatives that occur in a given model, etc. By way of example, the business problem can determine potential customers given a budget constraint, determine potential patients that are likely to suffer a medical illness given a length of stay, determine an incident of a fraudulent transaction given a number of transactions over a period of time, etc. Other types of business problems may be considered and still be within the scope of the subject technology.

The process at 210 selects a data source for a predictive model associated with a predictive algorithm. In one example, the predictive model includes one or more queries and parameters associated with the queries for processing data from the data source. Some examples of a data source may include a client data source such as data tables that are pushed to the MLSM server, or a server data source that is pulled from an external source such as a database. A parameter may specify a value, values, a range of values, etc., that a query attempts to match from querying data from the data source.

The process at 215 determines a set of transformations based on the queries and parameters for at least a subset of data from the data source to be processed by the predictive algorithm. The subset of data may be related to a case of data for the predictive algorithm. The set of transformations may include 1) a physical transformation, 2) a data space or distribution modification transformation, or 3) a business problem transformation. An example of a physical transformation includes binarization or encoding of data, such as categorical variables, into a format that is accessible by the predictive algorithm. An example of a data space transformation may be a mathematical operation(s) such as a logarithm performed on numerical data (e.g., price of a product, etc.) that reshapes the data for the predictive algorithm. In some configurations, the data space transformation is automatically performed based on the requirements of the actual predictive algorithm. For example, one algorithm identified by the MLSM may not accept numerical values for which the system will automatically convert such values to binned (e.g., categorical) values while not transforming the same value for algorithms that do accept numeric values. Similarly, an MLSM may define an algorithm that does not accept categorical values. In one example, the system will convert a categorical value into a series of numerical values where for each category a value of 0 means that the category was not observed and a value of 1 means that the value was observed. Algorithms that accept categorical values will not have the input transformed thusly in some implementations.

An example of a business problem transformation may include grouping more relevant data according to the objectives of the business problem. For example, customers that fall within zip codes or geographical areas close to a business of interest may be grouped together in a corresponding bucket, or other remaining customers in other zip codes or geographical areas may be grouped into another bucket for the predictive algorithm. The aforementioned types of transformations may include unary, binary or n-ary operators that are performed on data from the data source. In this manner, the process may provide data that is meaningful in a machine learning space associated with the predictive algorithm.

Another type of transformation that can be included involves one or more operations performed on an entirety of data available from a given data source. For instance, a row of data may include a column of data that is considered invalid (e.g., an age of a person that is out of range such as ‘999’). Thus, an example transformation may be provided that deletes or ignores the row in the data from the data source. Additionally, in an example in which a predictive model is predicting a rare event, a transformation may be provided that rebalances, amplifies, or makes more statistically prominent a portion(s) of the data according to the requirements of the predictive algorithm. For instance, a predictive algorithm that predicts instances of fraudulent transactions, which may be statistical insignificant among a set of data with an arbitrary size, may perform a rebalancing technique that amplifies the statistical significance of fraudulent data and reduces the statistical significant of instances of non-fraudulent data.

The process at 220 identifies a set of patterns based on the set of transformations for at least the subset of data from the data source. For instance, the process may determine patterns and correlations by scanning through the data according to the queries and parameters included in the predictive model. In this regard, one or more machine learning techniques may be utilized to identify patterns in the subset of data. By way of example, a neural network, logistic regression, linear regression, decision tree, naive Bayes classifier, Bayesian network, etc., may be utilized to determine patterns. Other examples may include rule systems, support vector machines, genetic algorithms, k-means clustering, expectation—maximization clustering, forecasting, and association rules. Other types of techniques or combination of techniques may be utilized to determine patterns in at least the subset of data and still be within the scope of the subject technology. By way of example, for a predictive model that attempts to predict which patients will have a high probability of failure in surgery, the process may determine that a patient has a high probability of failure in surgery if the following set of characteristics are identified in the data: 1) beyond a certain age, 2) overweight, 3) on anti-depressants, and 4) diabetic. An identified pattern may comprise a set of rules, a tree structure, or other type of data structure.

The process at 225 provides a trained predictive model including the determined set of patterns, the set of transformations, and the associated predictive algorithm for solving the specified business problem. The predictive algorithm may utilize queries, parameters for the queries and one or more machine learning techniques for solving the business problem. The process then ends. Although the above discussion applies to a single predictive model, the process in FIG. 2 may be utilized in order to provide several predictive models for solving the business problem. In this example, the process at 225 may select a best overall predictive model among the set of predictive models based on the constraint specified in the business problem. As mentioned before, the business problem may include a constraint that specifies a set of conditions that have to be met for the event. For instance, the constraint includes conditions that may specify a budget, different measures, a desired cost scenario, a ratio of a number of false positives and/or false negatives that occur in a given model, etc. Thus, the set of conditions specify a set of goals for the business problem, which may be expressed in a variety of ways, and the best overall predictive model may be a predictive model that best meets the set of conditions.

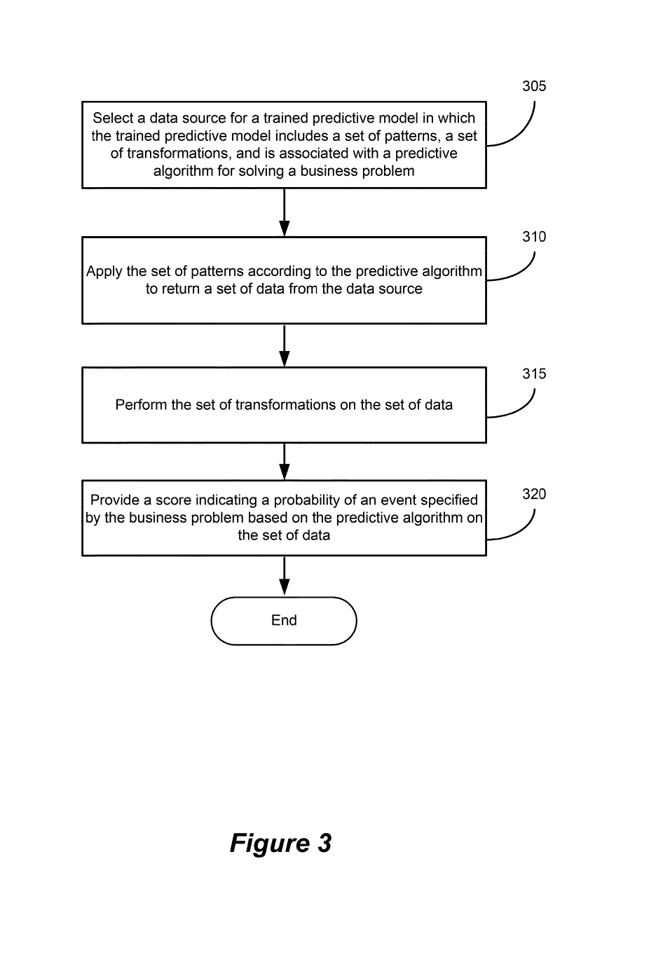

FIG. 3 conceptually illustrates an example process for scoring a predictive model for solving a business problem. The process may be performed conjunctively with the process described in FIG. 2. The process in FIG. 3 may be performed by one or more computing devices or systems in some configurations. More specifically, the process in FIG. 3 may be implemented by the MLSM (machine learning semantic model) server in FIG. 1.

The process at 305 selects a data source for a trained predictive model in which the trained predictive model includes a set of patterns, a set of transformations, and is associated with a predictive algorithm for solving a business problem. As mentioned before, the predictive algorithm may utilize queries, parameters for the queries, and machine learning techniques for identifying patterns in the data from the data source. In one example, the trained predictive model corresponds with a trained predictive model described at 225 in FIG. 2. The selected data source in one example may correspond with a different set of data than the data for training the predictive model described in FIG. 2. For instance, the data from the selected data source in FIG. 3 may include new data.

The process at 310 applies the set of patterns according to the predictive algorithm to return a set of data from the data source. The process at 315 performs the set of transformations on the set of data. For example, in an example in which the predictive algorithm requires an attribute for a length of stay, a transformation may be performed that computes the length of stay from attributes corresponding to a release data and an admissions date. As described before in FIG. 1, the set of transformations may include 1) a physical transformation, 2) a data space transformation, or 3) a business problem transformation. Additionally, a transformation involving a rebalancing technique may be performed in order to amplify or reduce a statistical significance of data.

As mentioned before, one type of transformation among the set of transformations may ignore or delete a row of data that is considered invalid (e.g., an invalid age). However, in the context of scoring the predictive model, such a type of transformation may not be performed in some instances. For example, if the predictive model is asking if a particular person may be considered a likely purchaser of a product, the process may not perform the transformation that deletes the data corresponding to the new customer even if the customer's data is invalid (e.g., customer's age is ‘999’). In this manner, the subject technology provides different ways of processing data during the training and scoring processes because these processes are handled separately by the MLSM server.

After performing the set of transformations, the process at 320 provides a score indicating a probability of an event specified by the business problem based on the predictive algorithm on the set of data. By way of example, the process performs the predictive algorithm on the set of data to provide a probability for indicating a likelihood of a patient having a heart attack, a likelihood that a transaction is fraudulent, a likelihood that a customer may purchase a product, etc., for a corresponding predictive model and business problem Although the discussion of FIG. 3 relates to a single predictive algorithm, the process in FIG. 3 may be applied for several predictive algorithms and still be within the scope of the subject technology. Further, the process at 320 may provide a set of scores instead of a single score.

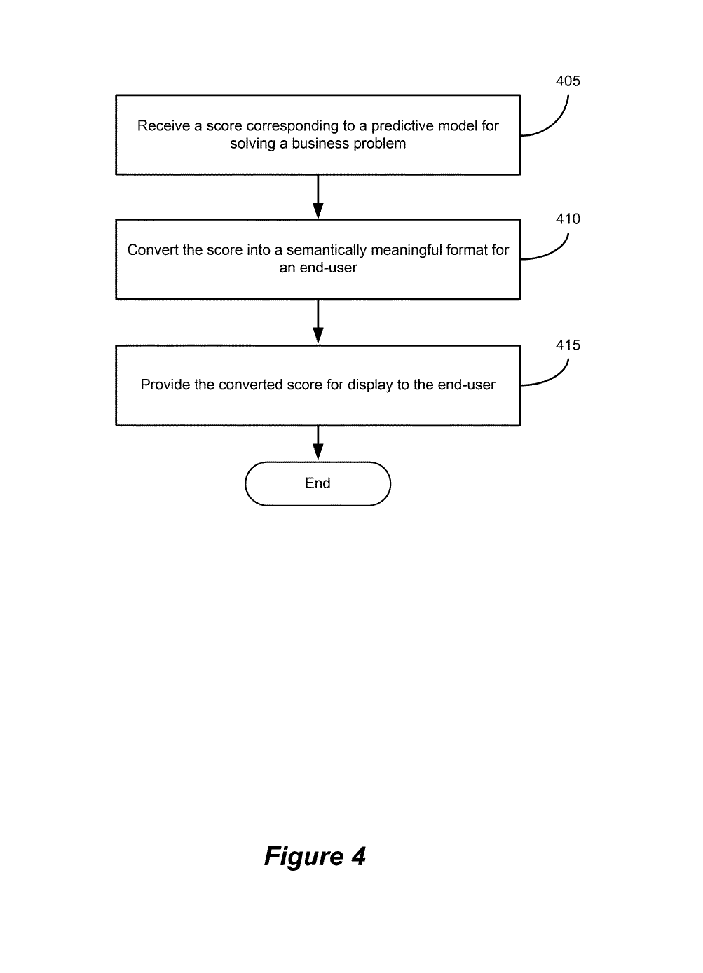

FIG. 4 conceptually illustrates an example process for performing post-processing of an output from scoring a predictive model. The process may be performed conjunctively with the processes described in FIG. 2 and FIG. 3. The process in FIG. 4 may be performed by one or more computing devices or systems in some configurations. More specifically, the process in FIG. 3 may be implemented by the MLSM (machine learning semantic model) server in FIG. 1.

In some instances, interpreting the score provided at 320 in FIG. 3 may prove difficult to an end-user. Thus, the process in FIG. 4 performs a set of post-processing operations in order convert the score to a format that is more semantically meaningful to an end-user.

The process begins at 405 by receiving a score corresponding to a predictive model for solving a business problem. The received score may correspond with a score provided at 320 in the process of FIG. 3.

The process at 410 converts the score into a semantically meaningful format for an end-user. In this regard, the process at 410 may perform a set of operations including assigning a label or labels to the score based on a set of conditions. In one example, based on a cost function or a constraint specified by the business problem, the score may be labeled accordingly. By way of example, for a predictive model that predicts a patient's probability of having a heart attack, the process may 1) label a given score with a value greater than 0.9 as “very high,” 2) label the score with a value between 0.6 to 0.9 as “high”, 3) label the score with a value between 0.4 to 0.6 as “medium”, or 4) label the score with a value lower than 0.4 as “low.” In this fashion, the process may assign a label to the score that is meaningful to the end-user. Other types of labels and descriptions may be assigned to the score and still be within the scope of the subject technology.

The process at 415 provides the converted score to an end-user. For instance, the converted score may be provided for display with its assigned label. The process then ends. In this manner, the process in FIG. 4 converts data that is outputted from the scoring process for the predictive model and provides a semantically meaningful representation of the data to the end-user.

In addition to the above described processes for training, scoring and post-processing a predictive model, the MLSM server may publish the predictive model so that another end-user or enterprise may utilize the published predictive model for their own data, modify the predictive model, and then generate a new predictive model tailored to the data and particular needs of the other end-user or enterprise. The published predictive model may be in a data format such as XML or a compressed form of XML in one example.

Some configurations of the subject technology allow a semantically similar set of data to the data utilized in training to be projected over the identified patterns during training As described before (e.g., in FIG. 1), a set of patterns may be identified during training of a predictive model.

By way of example, if a pattern is identified during training that indicates people with blue eyes and dark hair tend to drive red cars, then the MLSM server may project all customers in the data set over the identified pattern to determine which customers fall within the identified pattern. These customers may then be grouped in a category associated with the detected pattern. Further, for the customers that are grouped according to the identified pattern, other attributes may be determined such as an average income or average age, other demographic information, etc., within that group of customers that were not originally included during the training process.

In another example, the data may be scanned to detect different single attributes such as state, country, or age during the training process of the predictive model. After patterns are indentified during training, it may be determined that groups of people share a detected pattern. Thus, each group is an entity that is discovered during the training of a predictive model.

In yet another example, a tree may be built for a predictive model in which one or more branches of the tree indicates different attributes for an event. For instance, in an example predictive model that predicts a likelihood of a person having a heart attack, a branch of this tree may indicate that if a person is over eighty (80) years old, diabetic, and obese then that person is likely to have a heart attack. The subject technology may then analyze branches of the tree to determine which instances resulted in a fatality. Subsequently, it may be determined that people with the most instances of heart attacks did not always result in a fatality. Consequently, an enterprise (e.g., hospital) may be able to divert resources that were previously assigned to people with the most instances of heart attacks over to a new group of people in which a likelihood of a fatality is much greater, which may result in a more efficient usage of the enterprise's resources.

In view of the above, the identified patterns during training enable the MLSM server to project new data for the data set that was not discerned by identifying patterns alone during the training process of the predictive model.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

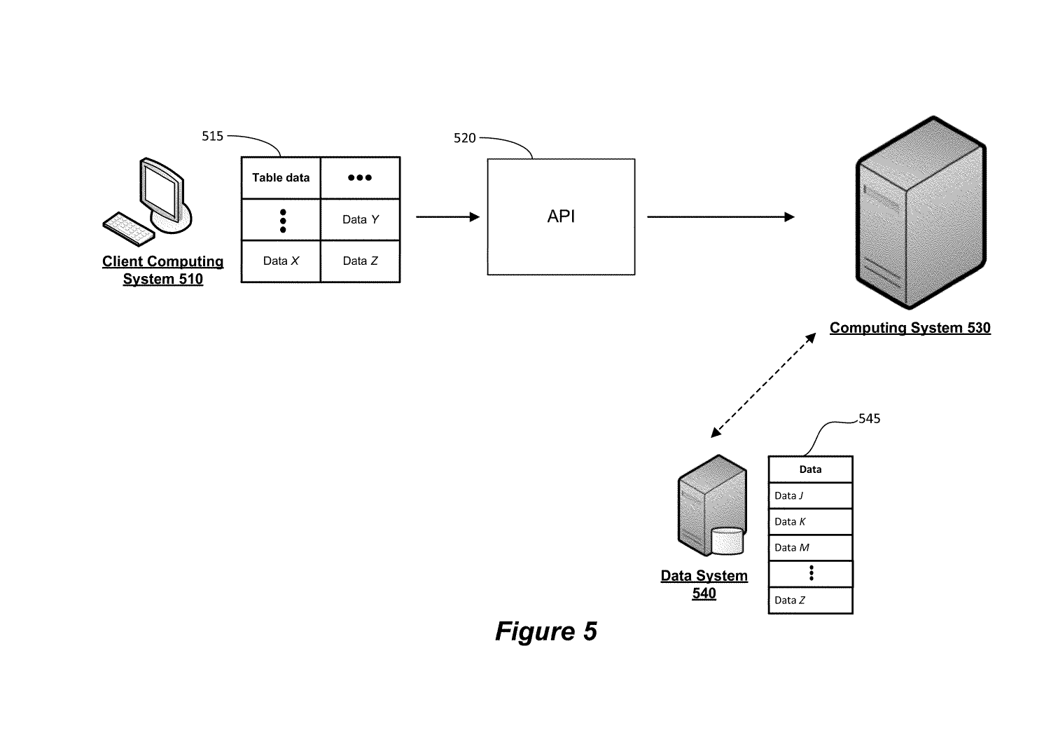

FIG. 5 conceptually illustrates an example communication flow from a client computing system to a machine learning semantic model (MLSM) server for pushing data to the MLSM server.

As illustrated in FIG. 5, a client computing system 510 may include a spreadsheet application that includes table data 515 representing a table including rows and columns of data for processing by a predictive model. For instance, an end-user may import data that the end-user wishes to score in a predictive model, such as customer or patient data, into a table provided by the spreadsheet application. Thus, the spreadsheet application serves as a client front-end for communicating with the MLSM server as provided in a computing system 530. In this regard, the client computing system 510 may make one or more API calls provided by an API 520 in order to push data from the table data 515 over to the MLSM server provided in a computing system 530 for scoring. The results of the scoring may then be populated back into the table data 515 provided by the spreadsheet application.

In another example, the end-user may utilize the spreadsheet application for processing data located in a different location, such as an SQL server provided in a data system 540 that provides data 545. In this example, the end-user may utilize the spreadsheet application to point to the data located on the SQL server and then send one or more API calls provided by an API 520 in order to instruct the MLSM server to apply a trained predictive model on the data 545 on the SQL server. The results of applying the predictive model are then stored on the SQL server. In further detail, once the MLSM server receives the API calls from the end-user, the MLSM server pushes the predictive model and some custom code into the SQL server so that the SQL server may execute the desired commands or functions. In one example, the SQL may allow for custom code to be executed by the SQL server via support of extended procedures that provide functions for applying the predictive model. As a result, the data is not required to leave the domain of the SQL server when applying the predictive model.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, a combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in a form of programming language, including compiled or interpreted languages, declarative or procedural languages, and it can be deployed in some form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The following discussion relates to examples for user interfaces in which configurations of the subject technology be implemented. More specifically, the following examples relate to creating a predictive model that predicts whether a patient will be readmitted to a hospital based on a length of stay. In some configurations, the predictive model, after being created, may be applied on a new set of data.

In some configurations, the quality of hospital care may be measured, in part, by a number of patients that are readmitted to a hospital after a previous hospital stay. Hospital readmissions may be considered wasteful spending for the hospital. Thus, identifying which patients that are likely to be readmitted may be beneficial to improving the quality of the hospital. A readmission can be defined as any admission to the same hospital occurring within a predetermined number of days (e.g., 3, 7, 15, 30 days, etc.) after discharge from the initial visit in some examples. In this regard, the subject technology may be utilized to create a predictive model to determine potential patients that are likely to suffer a medical illness given a length of stay and/or when a set of characteristics are identified in data pertaining to a patient(s).

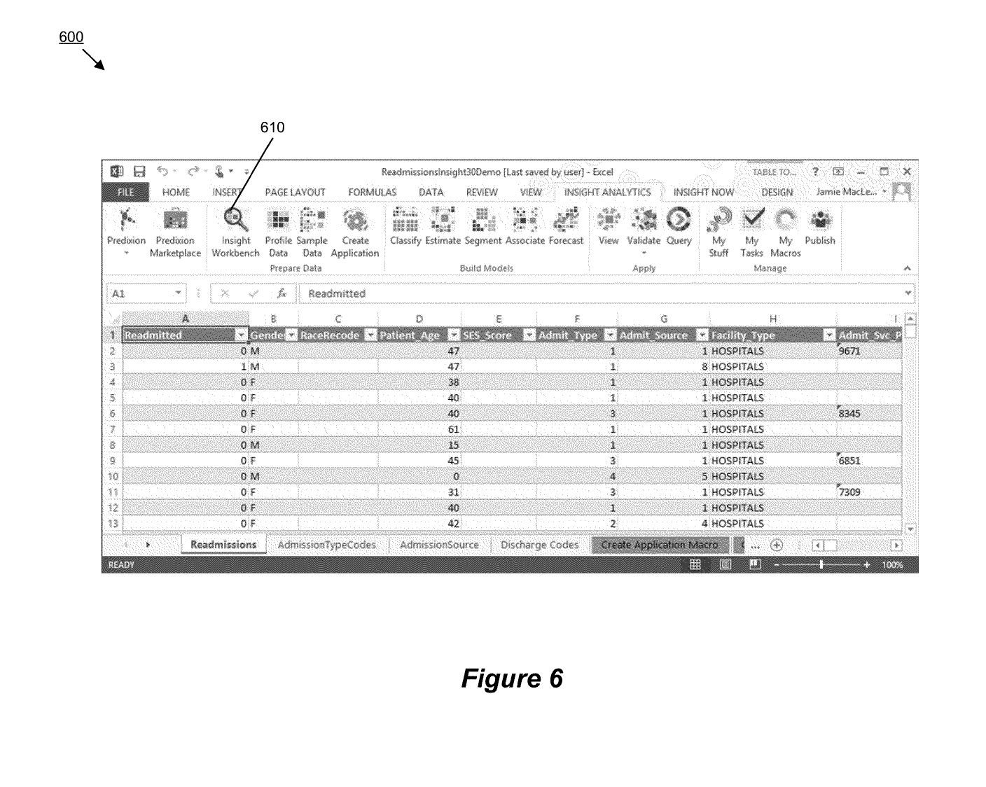

In some configurations, the subject technology may provide a tool(s) (e.g., plugin, extension, software component, etc.) that extends the functionality of a given spreadsheet application. As illustrated in FIG. 6, a GUI 600 may be provided by a spreadsheet application. A user may activate the tool by selecting a graphical element 610.

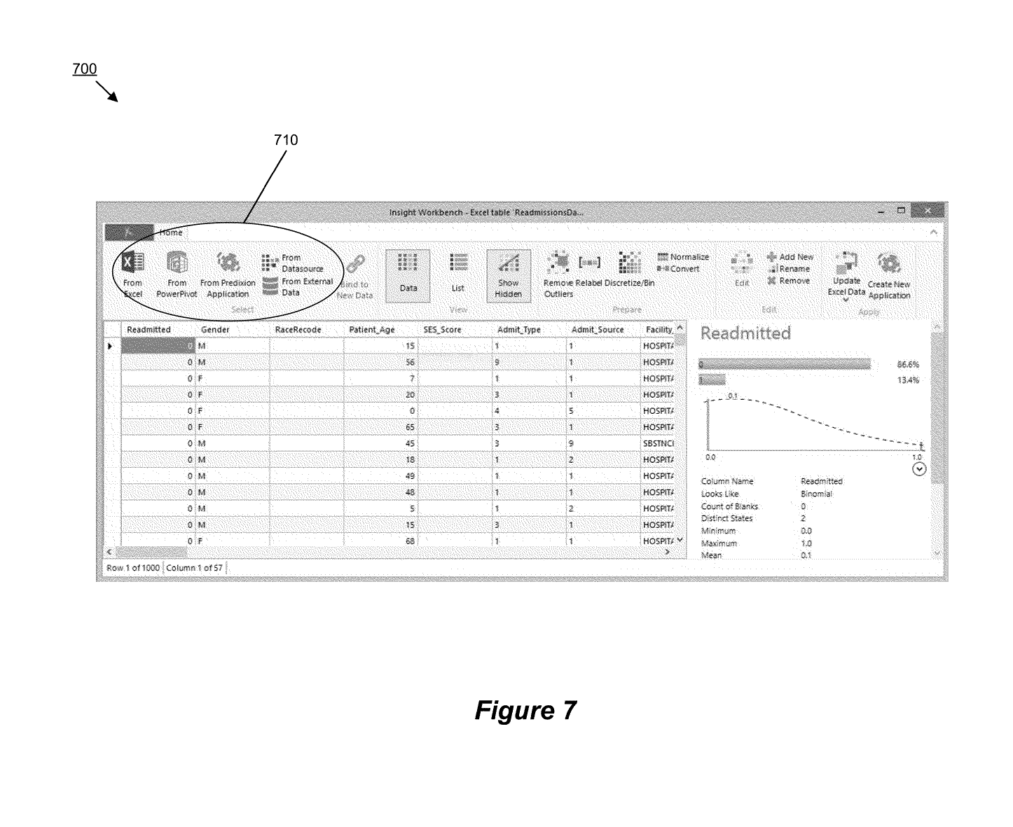

FIG. 7 illustrates an example GUI 700 for accessing one or more data sources. Upon activation of the tool, the GUI 700 may be provided by the spreadsheet application. The subject technology may access data from one or more data sources (e.g., from the spreadsheet application, from another application(s), from a given data source or database, etc.) to apply to the predictive model. As shown, a set of graphical elements 710 are included in the GUI 700 that represent respective data sources that may be selected for accessing. Other types of data sources may be provided and still be within the scope of the subject technology.

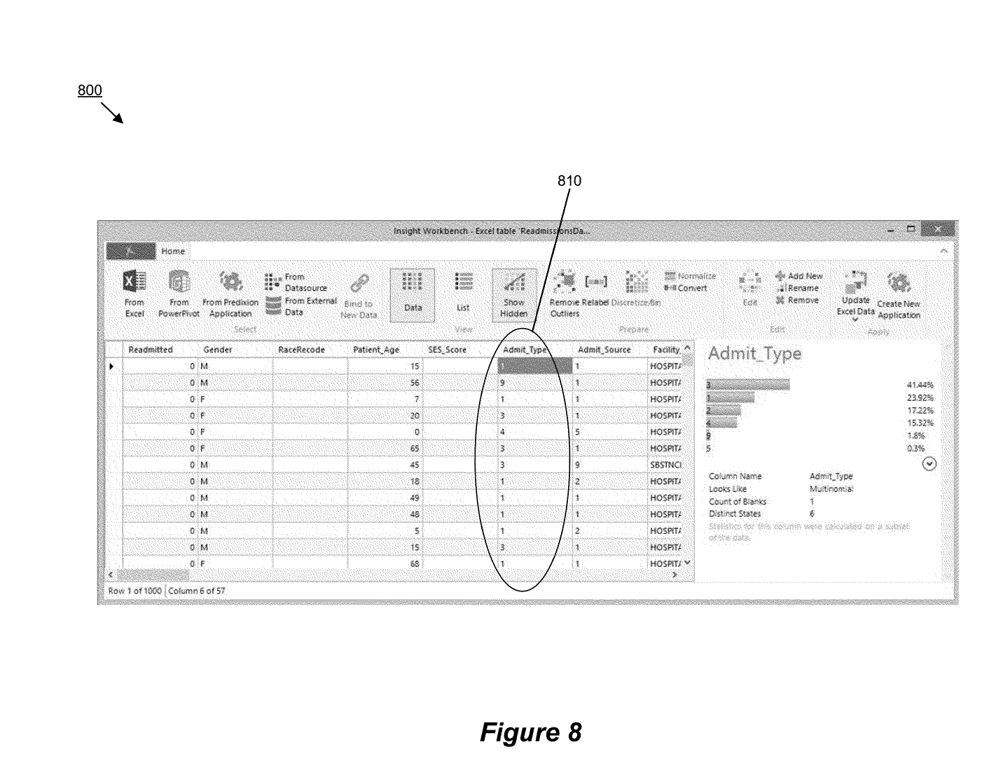

FIG. 8 illustrates an example GUI 800 for selecting data in an column 810 that includes encoded data. The data shown in FIG. 8 may represent a training set of data (e.g., a subset of data from a given data source). Data from a data source may be encoded in a given format(s) or according to a given scheme which may not be easily interpreted by a user. The column 810 in this example includes encoded data (e.g., in various numerical values) corresponding to a type of admission at a hospital.

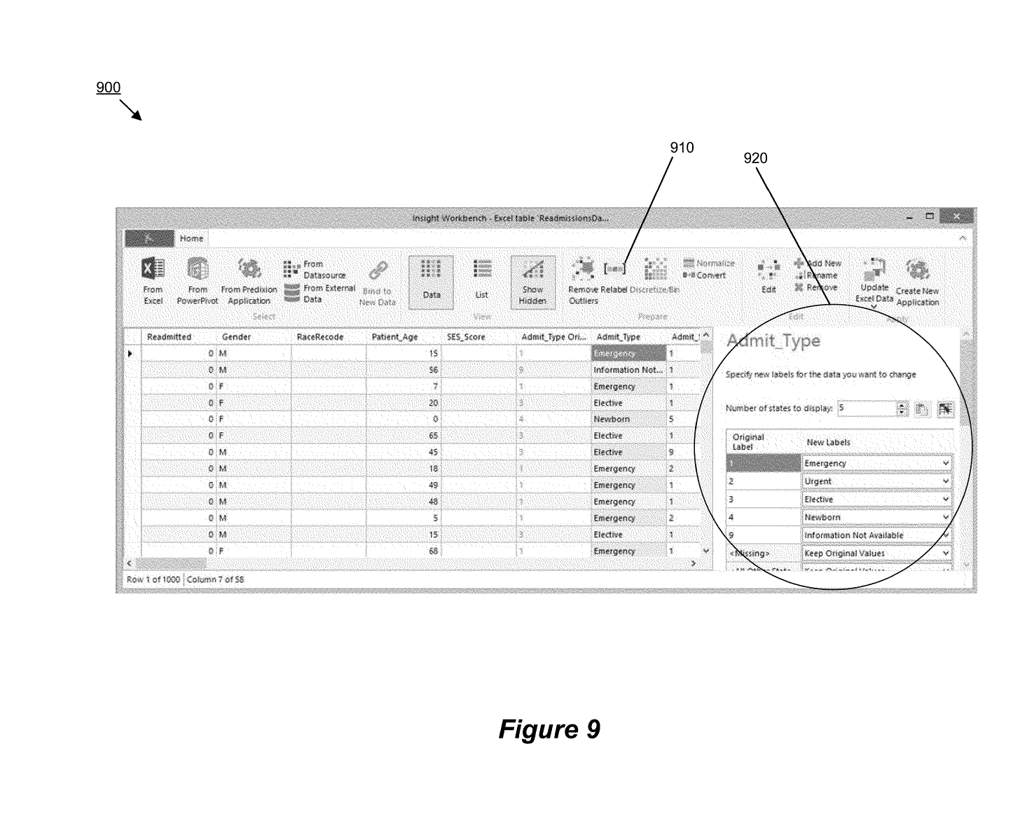

FIG. 9 illustrates an example GUI 900 for decoding encoded data (e.g., from FIG. 8). In this example, a user may select a graphical element 910 to perform relabeling of the encoded data. Upon selection of the graphical element 910, the GUI 900 may provide for display a set of graphical elements 920 to assign respective labels to corresponding encoded data. For instance, encoded data with values of “1,” “2,” “3,” “4,” and “9,” and may be assigned new labels of “Emergency,” “Urgent,” “Elective,” “Newborn,” and “Information Not Available,” respectively. Further, encoded data in which the value is missing (e.g., denoted by “<Missing>”) may be set to keep its original value (e.g., denoted as “Keep Original Value”).

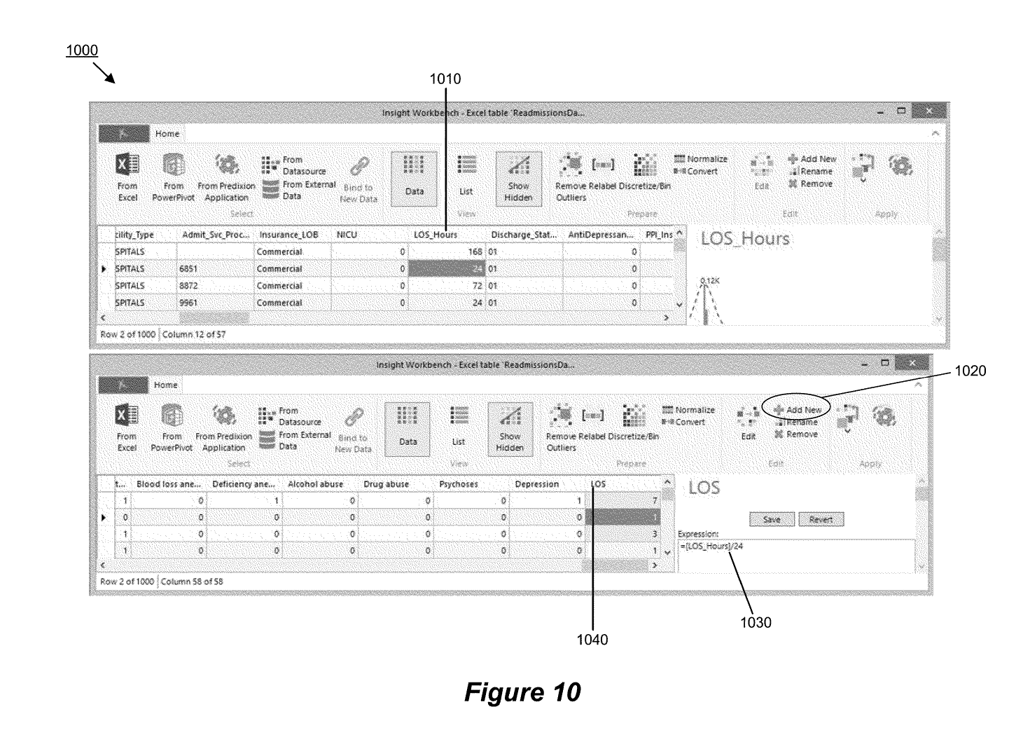

FIG. 10 illustrates an example GUI 1000 for performing a business transformation on a column of data. In this example, a user may select a column of data 1010 corresponding to a length of stay for a patient indicated in an amount of hours. A business transformation may then be applied to the column of data 1010 to convert the length of stay into an amount of days. In this regard, the GUI 1000 may provide a graphical element 1020 for adding a new transformation. A textbox 1030 (or similar graphical element) may then be provided by the GUI 1000 to enable the user to enter in an expression to transform the data (e.g., a combination of values, constants, variables, operators, or functions that are interpreted according to rules of precedence and association, which produces another value). Upon applying the business transformation, a column 1040 may be provided by the GUI 1000 that includes length of stay in days (e.g., the transformed data) for the original data corresponding to the length of stay in hours from the column 1010.

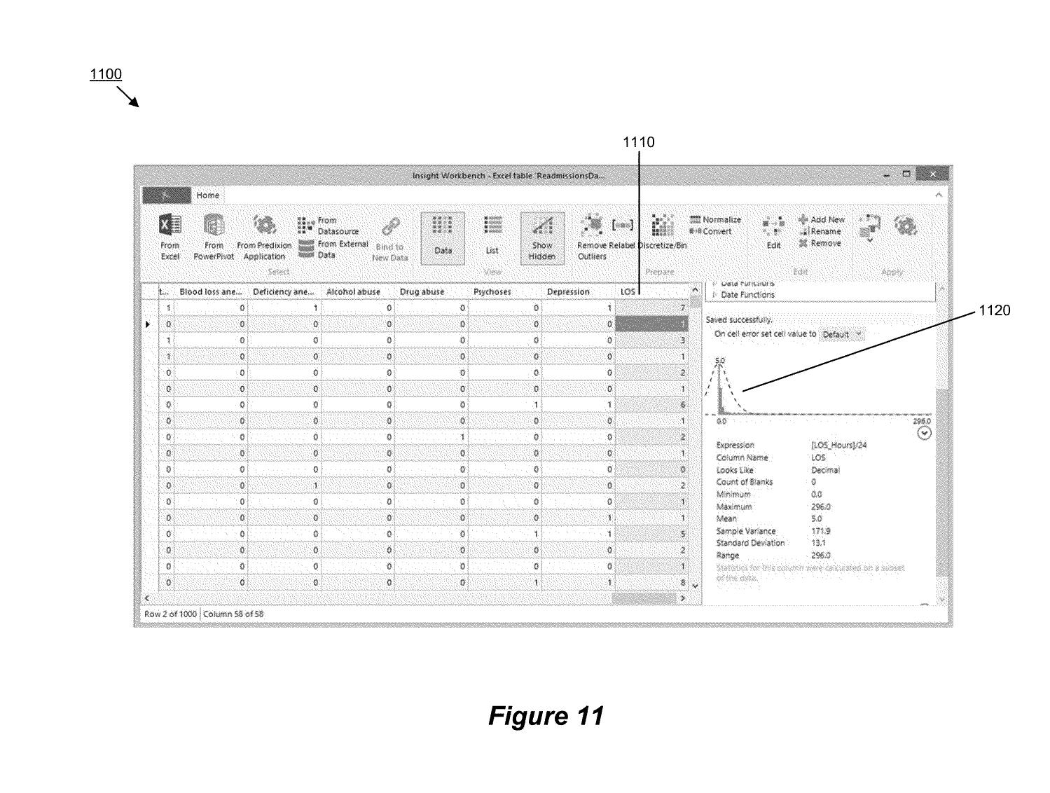

FIG. 11 illustrates an example GUI 1100 including a column 1110 with data that may include a skewed distribution. A skewed distribution of data may indicate a presence of one or more outlier values in the data. As shown in the GUI 1100, a distribution 1120 is provided visually represent the distribution of data from the column 1110. The distribution 1120 in this example indicates an outlier value of “296.0.”

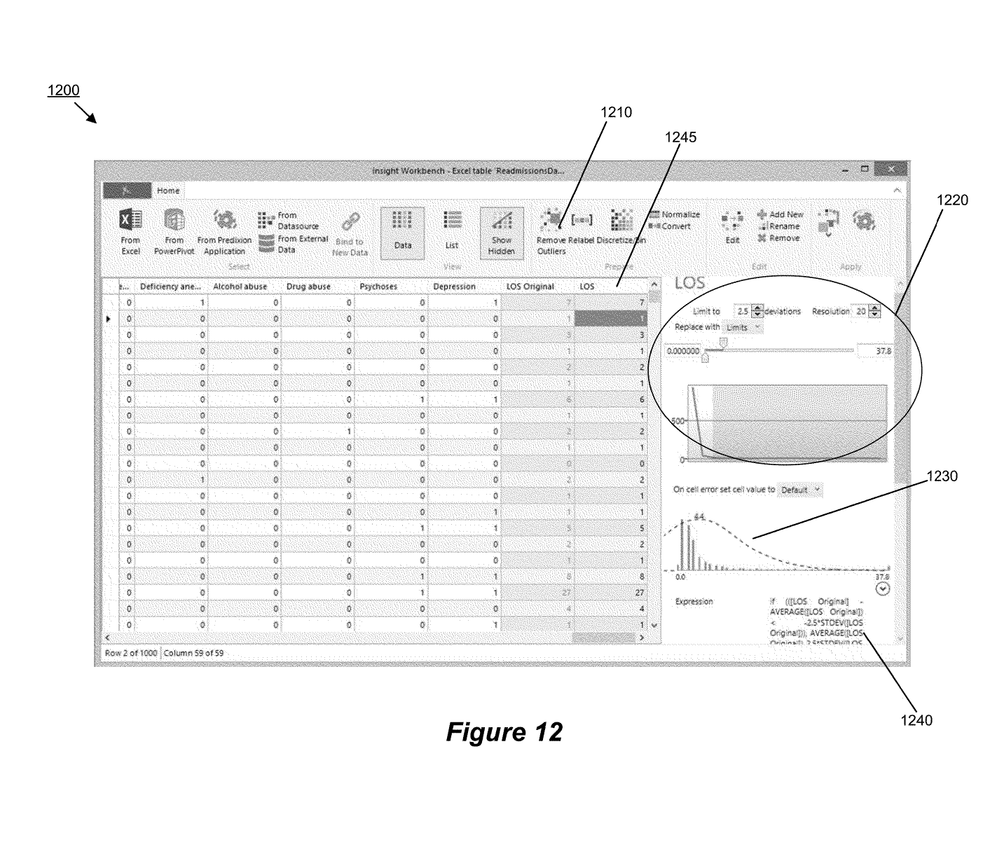

FIG. 12 illustrates an example GUI 1200 including a set of graphical controls for removing outliers in a set of data. As shown, the GUI 1200 includes a graphical element 1210 that upon selection by a user activates a set of controls 1220. The set of controls 1220 may enable a user to adjust one or more parameters to remove outlier values in a set of data (e.g., data from the column 1110). An updated distribution 1230 may be provided and a column 1245 may include updated data after removing outlier(s) values according to the set of controls 1220. Further, the GUI 1200 may provide an expression 1240 that is automatically generated based on the parameters as configured by the set of controls 1220.

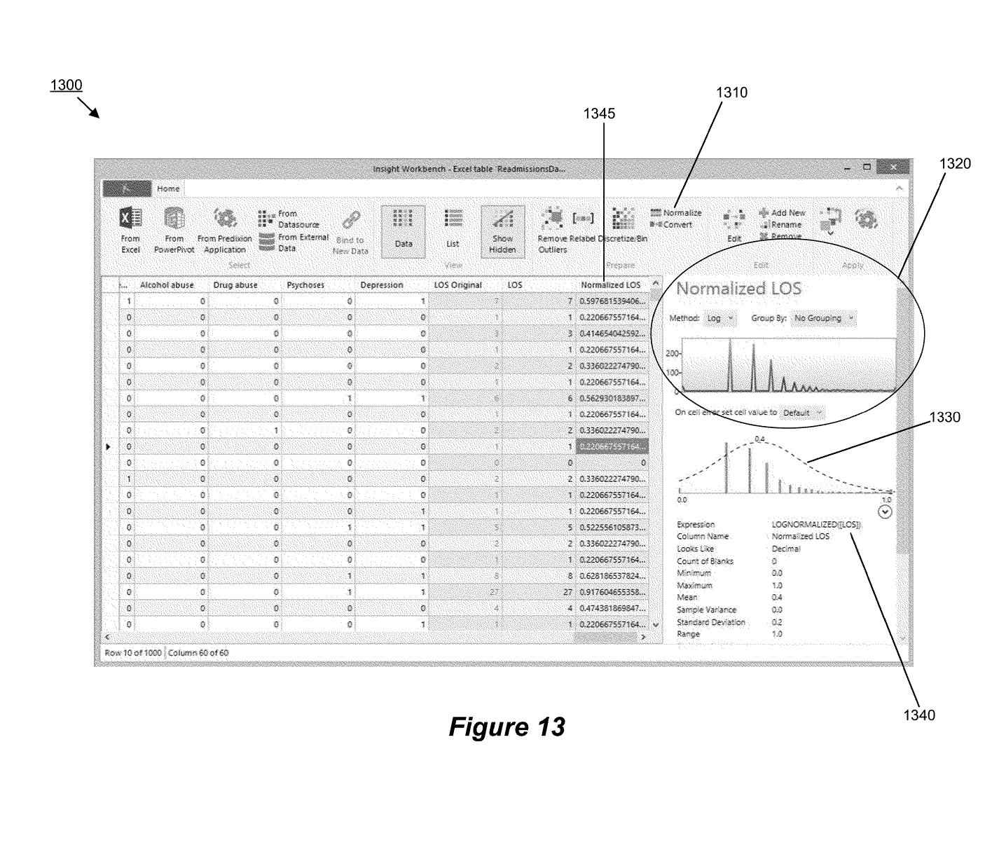

FIG. 13 illustrates an example GUI 1300 including a set of graphical controls for normalizing a given set of data. As shown, the GUI 1300 includes a graphical element 1310 that upon selection by a user activates a set of controls 1320. The set of controls 1320 may enable a user to adjust one or more parameters to perform normalization of a set of data. In this example, the set of data includes data after one or more outliers have been removed as described in FIG. 12 (e.g., data from the column 1245). An updated distribution 1330 may be provided and a column 1345 may include updated data after performing normalization of the set of data that displays a distribution that covers a range of values that is more informative to the user. Further, the GUI 1300 may provide an expression 1340 that is automatically generated from the parameters as configured by the set of controls 1320.

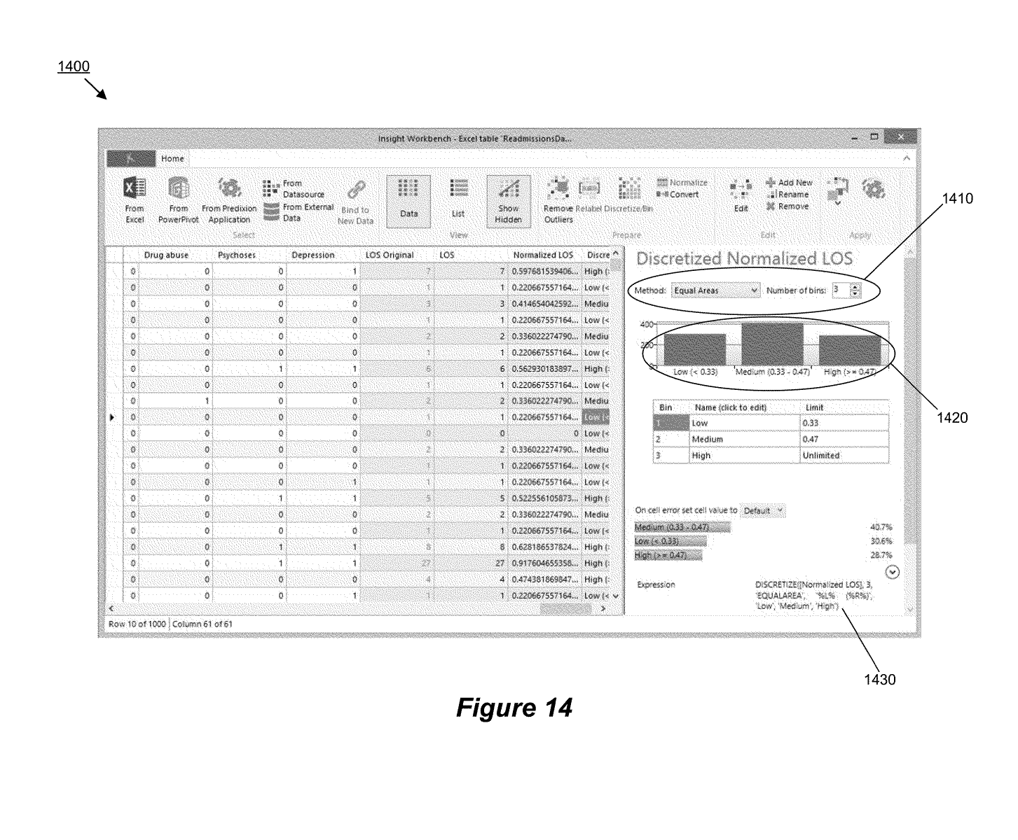

FIG. 14 illustrates an example GUI 1400 including a set of graphical controls for binning a set of data. In some example, binning may be a form of post-processing performed on a set of data to reduce or de-emphasize the effects of error(s). In the example shown in FIG. 14, data values which fall in a predefined range of values (e.g., a bin) are replaced by a value representative of that range of values. A set of controls 1410 are provided by the GUI 1400 that enables a user to configure different parameters for binning the set of data. As shown, a control for selecting a method of binning and a control for setting a number of bins are provided in the GUI 1400. An updated distribution 1420 may be provided based on the parameters as configured by the set of controls 1410 that displays the data in three respective bins according to a range of values (e.g., low, medium and high). Additionally, the GUI 1400 may provide an expression 1430 that is automatically generated from the parameters based on the set of controls 1420. In some configurations, the data divided into respective bins is utilized by a given predictive algorithm(s) as the binned data represents a finalized version of the data after performing the set of transformations.

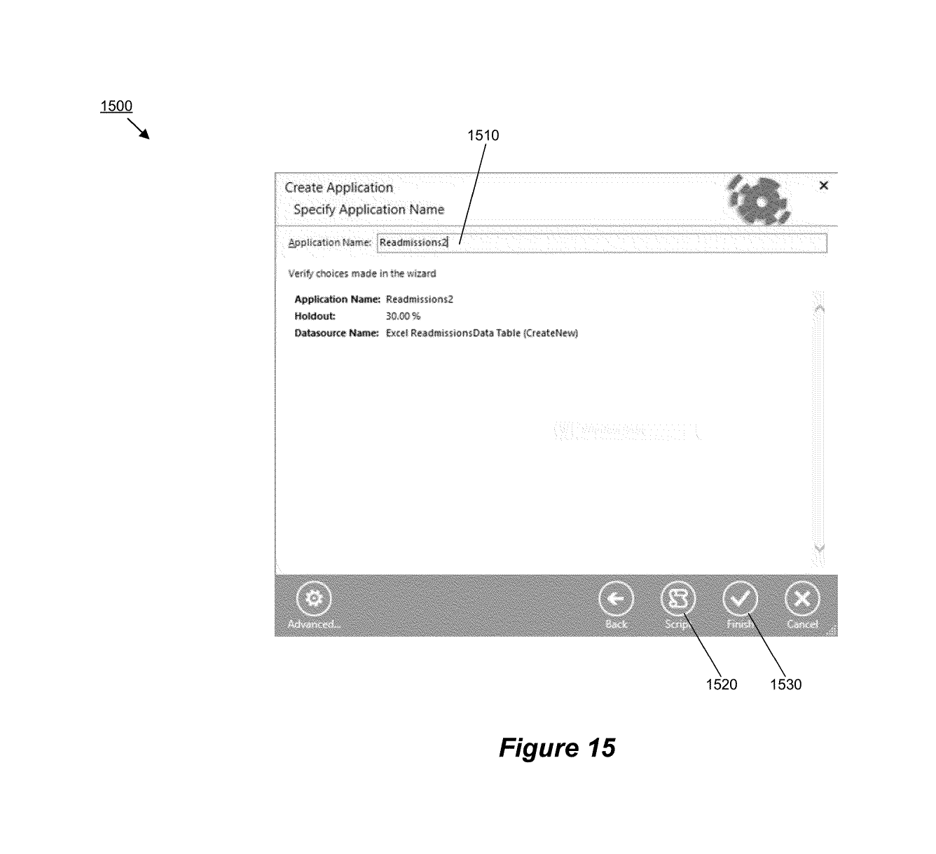

FIG. 15 illustrates an example GUI 1500 for creating an application that represents a predictive model. The GUI 1500 provides a textbox 1510 that enables a user to enter in a name for the predictive model (e.g., the “application”). The GUI 1500 further provides graphical elements 1520 and 1530 for generating a script corresponding to the predictive model or executing the predictive model, respectively. In some configurations, executing the predictive model via the graphical element 1530 generates the script and then executes the script. In one example, the generated script includes one or more instructions to be performed on a set of data. Once the script is generated, the subject technology may transmit the generated script to a MLSM server for execution. At this point, the data may be uploaded to the MLSM server or the MLSM server may fetch the data from one or more data sources (e.g., as specified in the script) for storing on the MLSM server. The data stored on the MLSM server may represent a testing set of data in which the predictive model is applied on. As shown, a testing set of data is indicated as being 30% held out (e.g., shown as “Holdout: 30.00%”), which means that 30% of an aggregate set of data (e.g., 30% of 100,000 rows of data) from the data sources may be saved on the MLSM server for executing against the script. Additionally, a server object may be created by the MLSM server that represents the predictive model, which in turn may be published to a shared collection of models and collaborated upon in the future by other users. The MLSM server proceeds to execute the script on the data at the server and perform any transformations or operations described in the examples of FIGS. 9-14.

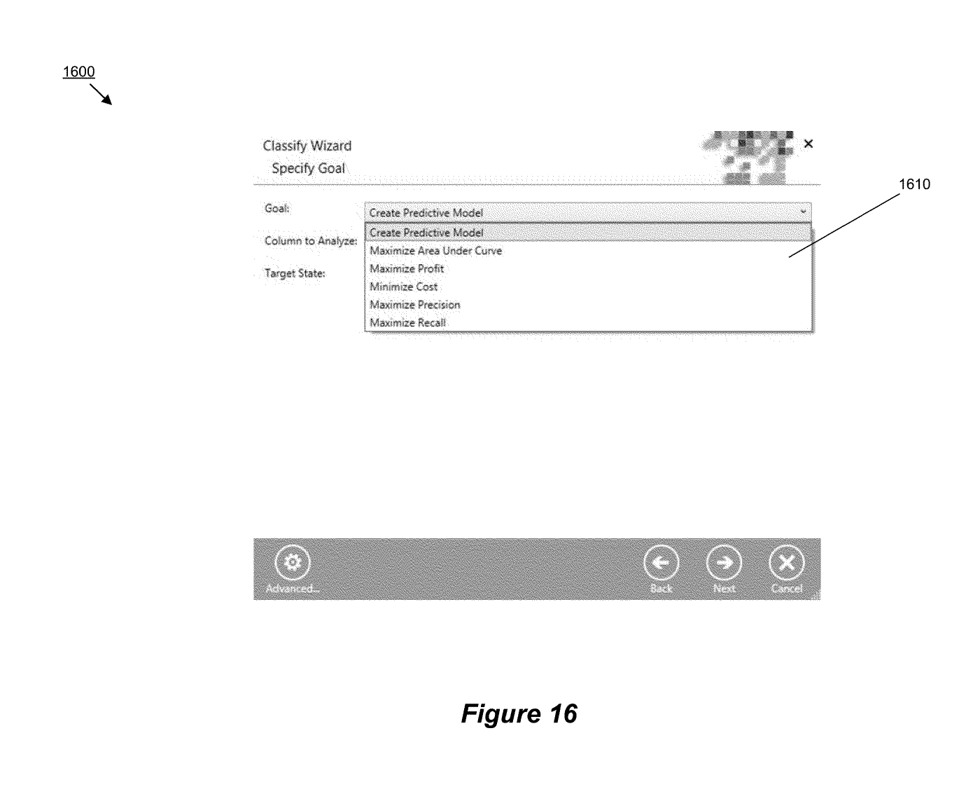

FIG. 16 illustrates an example GUI 1600 for specifying a goal(s) of one or more predictive models. In this regard, a specified goal of a predictive model may indicate a constraint as defined by a given business problem. As shown in the GUI 1600, a dropdown list 1610 may include several options that specify a respective goal of a predictive model. Some goals may include maximizing an area under a curve, maximizing profit, minimizing cost, maximizing precision or maximizing recall. In this manner, the subject technology enables a user to create different goals for one or more predictive models for applying on a given set of test data. Other types of goals may be provided and still be within the scope of the subject technology.

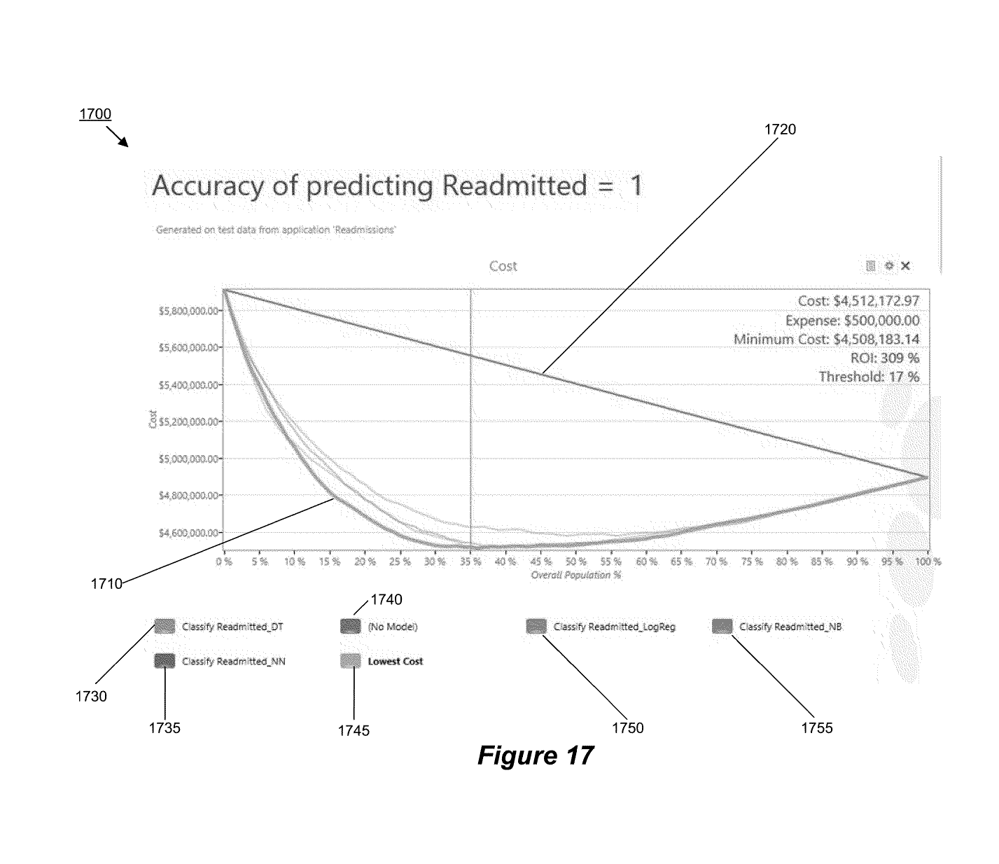

FIG. 17 illustrates an example GUI 1700 for automatic selection of a best model based on a goal. A graph is provided in the GUI 1700 that displays respective curves for the results of different models based on the following techniques or algorithms: 1) decision tree 1730; 2) neural network 1735; 3) no model 1740; 4) logistic regression analysis 1750; and 5) naïve Bayes classifier. As shown, a curve 1710 represents a lowest cost (e.g., the constraint specified by the business problem) which may be compared to other curves representing respective results of different predictive models. A line 1720 represents a plot where no predictive model was utilized. In one example, the best model may be determined by identifying a curve that substantially matches the lowest cost curve at a given cost point.

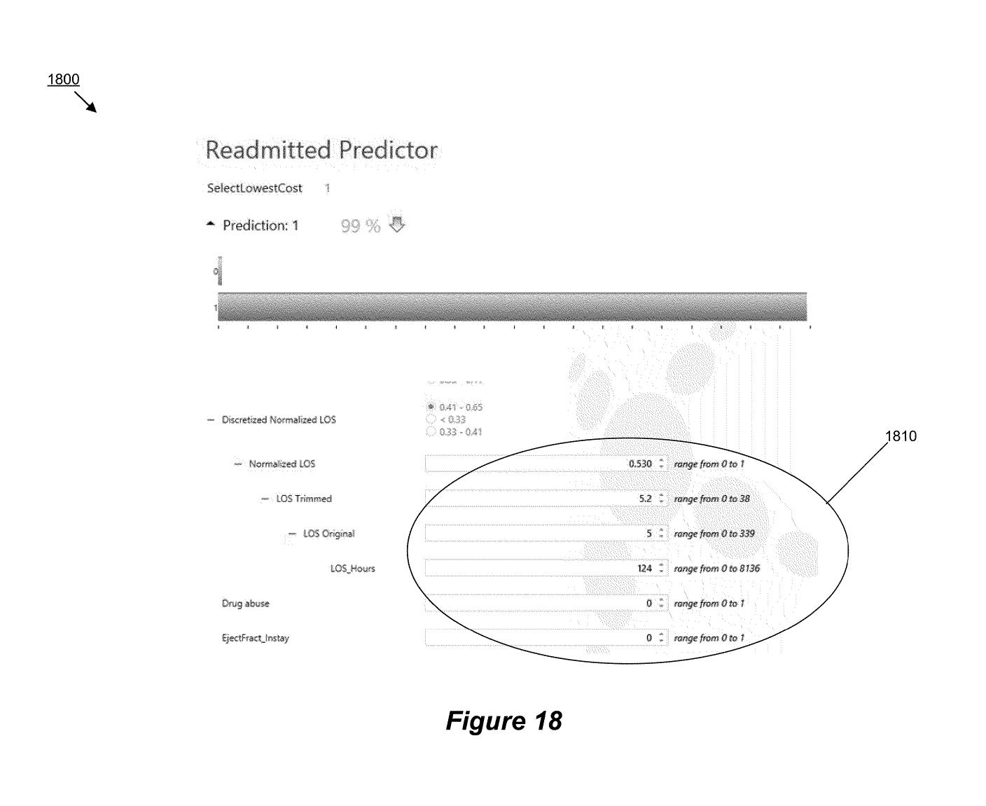

FIG. 18 illustrates an example GUI 1800 for providing a transformation pipeline in a query tool. As shown, a set of graphical elements 1810 enables a user to specify different values for various data values to bind a set of transformations to the specified data values. In some configurations, the various data values that are provided in the GUI 1800 are based on how the user builds the predictive model (e.g., described before in FIGS. 9-14).

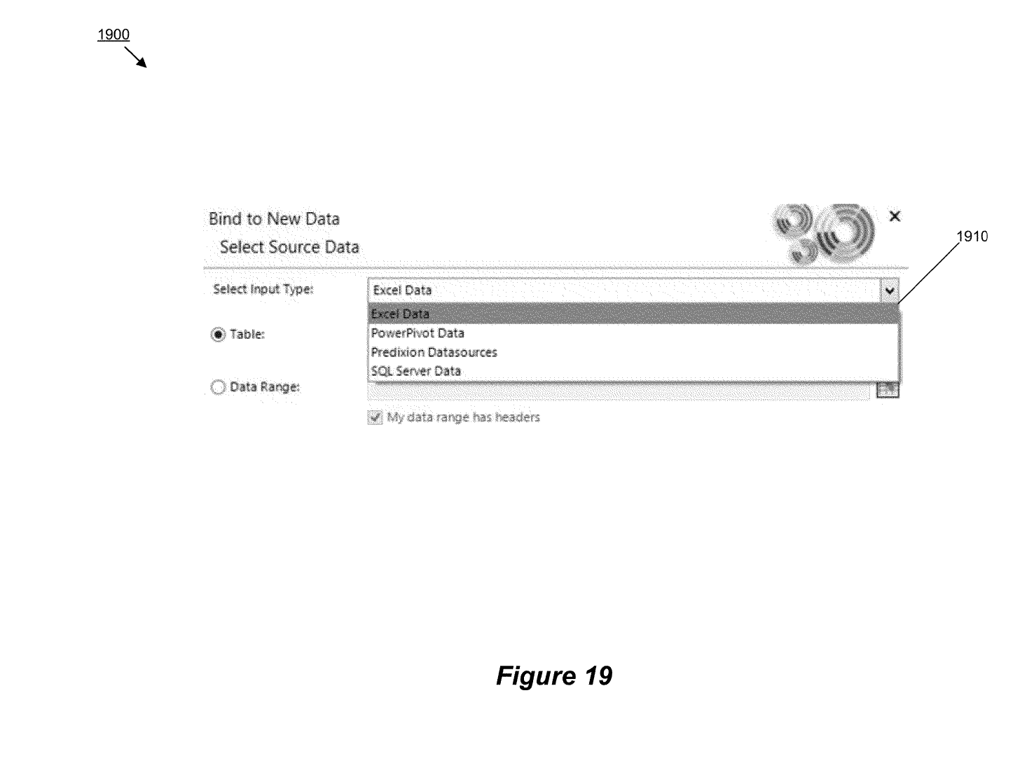

FIG. 19 illustrates an example GUI 1900 for applying a predictive model to new data. As shown, a dropdown list 1910 with several options is provided by the GUI 1900 to enable a user to set a type of data for applying the predictive model. For instance, the predictive model may be applied to data included in a given spreadsheet, a given external data source (e.g. Hadoop), data in a given database format (e.g., SQL), etc. In this manner, a predictive model that has been created may be reutilized and applied to a new set of data. In this example, the predictive model for predicting whether a patient will be readmitted to a hospital based on a length of stay may be applied to a new set of data. In some configurations, each data transformation from the transformation pipeline based on the predictive model is executed within and then stored into the external database or data source as well (e.g., without requiring an external copying of the data).

The following description describes an example system in which aspects of the subject technology can be implemented.

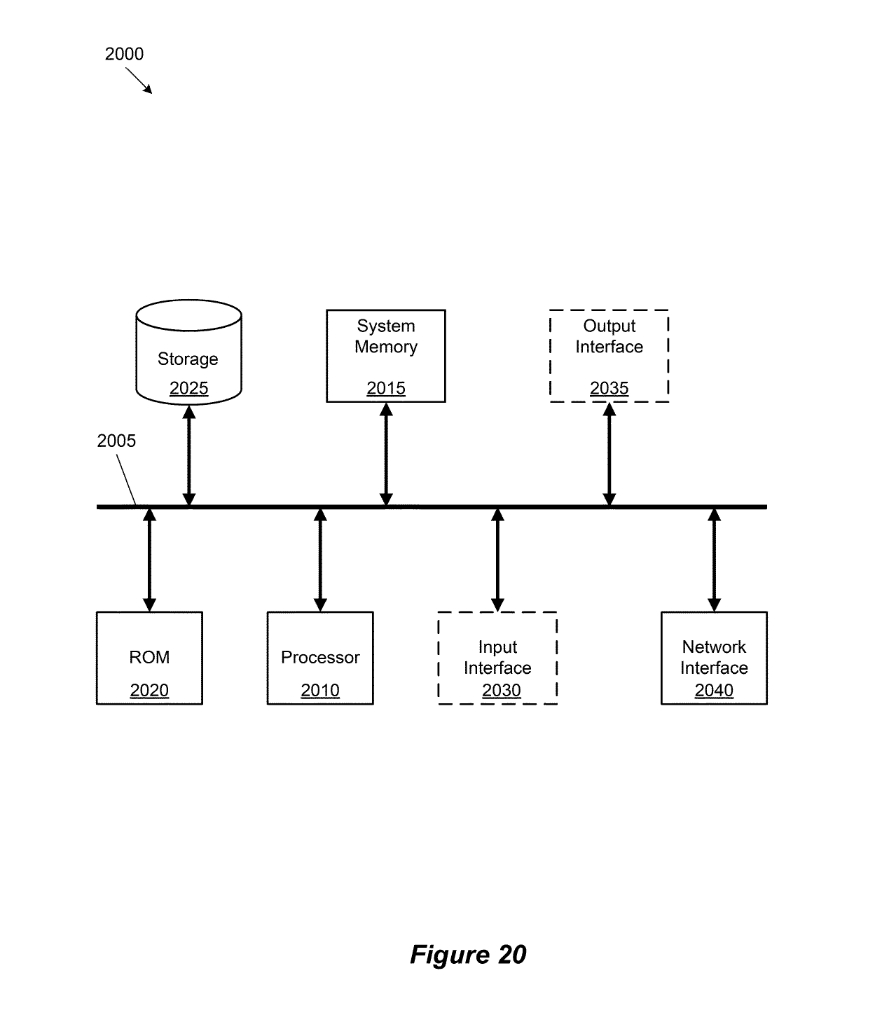

FIG. 20 conceptually illustrates a system 2000 with which some implementations of the subject technology can be implemented. The system 2000 can be a computer, phone, PDA, or another sort of electronic device. Such a system includes various types of computer readable media and interfaces for various other types of computer readable media. The system 2000 includes a bus 2005, processing unit(s) 2010, a system memory 2015, a read-only memory 2020, a storage device 2025, an optional input interface 2030, an optional output interface 2035, and a network interface 2040.

The bus 2005 collectively represents all system, peripheral, and chipset buses that communicatively connect the numerous internal devices of the system 2000. For instance, the bus 2005 communicatively connects the processing unit(s) 2010 with the read-only memory 2020, the system memory 2015, and the storage device 2025.

From these various memory units, the processing unit(s) 2010 retrieves instructions to execute and data to process in order to execute the processes of the subject technology. The processing unit(s) can be a single processor or a multi-core processor in different implementations.

The read-only-memory (ROM) 2020 stores static data and instructions that are needed by the processing unit(s) 2010 and other modules of the system 2000. The storage device 2025, on the other hand, is a read-and-write memory device. This device is a non-volatile memory unit that stores instructions and data even when the system 2000 is off. Some implementations of the subject technology use a mass-storage device (such as a magnetic or optical disk and its corresponding disk drive) as the storage device 2025.

Other implementations use a removable storage device (such as a flash drive, a floppy disk, and its corresponding disk drive) as the storage device 2025. Like the storage device 2025, the system memory 2015 is a read-and-write memory device. However, unlike storage device 2025, the system memory 2015 is a volatile read-and-write memory, such a random access memory. The system memory 2015 stores some of the instructions and data that the processor needs at runtime. In some implementations, the subject technology's processes are stored in the system memory 2015, the storage device 2025, and/or the read-only memory 2020. For example, the various memory units include instructions for processing multimedia items in accordance with some implementations. From these various memory units, the processing unit(s) 2010 retrieves instructions to execute and data to process in order to execute the processes of some implementations.

The bus 2005 also connects to the optional input and output interfaces 2030 and 2035. The optional input interface 2030 enables the user to communicate information and select commands to the system. The optional input interface 2030 can interface with alphanumeric keyboards and pointing devices (also called “cursor control devices”). The optional output interface 2035 can provide display images generated by the system 2000. The optional output interface 2035 can interface with printers and display devices, such as cathode ray tubes (CRT) or liquid crystal displays (LCD). Some implementations can interface with devices such as a touchscreen that functions as both input and output devices.

Finally, as shown in FIG. 20, bus 2005 also couples system 2000 to a network interface 2040 through a network adapter (not shown). In this manner, the computer can be a part of a network of computers (such as a local area network (“LAN”), a wide area network (“WAN”), or an Intranet, or an interconnected network of networks, such as the Internet. The components of system 2000 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and the claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and the claims of this application, the terms “computer readable medium” and “computer readable media” are entirely restricted to tangible, physical objects that store information in a form that is readable by a computer. These terms exclude wireless signals, wired download signals, and other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be a form of sensory feedback, e.g., visual feedback, auditory feedback, or tactile feedback; and input from the user can be received in a form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or a combination of one or more such back end, middleware, or front end components. The components of the system can be interconnected by a form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that a specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable a person skilled in the art to practice the various aspects described herein. Various modifications to these aspects will be readily apparent to those skilled in the art, and the generic principles defined herein can be applied to other aspects. Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method, the method comprising:
specifying a business problem to determine a probability of an event occurring in which the business problem includes a constraint;
selecting a data source for a predictive model associated with a predictive algorithm in which the predictive model includes one or more queries and parameters;
determining a set of transformations based on the queries and parameters for at least a subset of data from the data source to be processed by the predictive algorithm;
identifying a set of patterns based on the set of transformations for at least the subset of data from the data source; and
providing a trained predictive model including the determined set of patterns, the set of transformations, and the associated predictive algorithm for solving the specified business problem.

2. The method of claim 1, wherein the constraint comprises a set of conditions for the event to occur.

3. The method of claim 2, wherein the set of conditions comprises one of a specified budget, a cost scenario, and a ratio of a number of false positives or false negatives that occur in a respective predictive model.

4. The method of claim 1, wherein the predictive model includes one or more queries and parameters associated with the queries for processing data from the data source.

5. The method of claim 4, wherein the parameters specify a value, values, or a range of values that a respective query from among the queries match from querying data from the data source.

6. The method of claim 1, wherein the data source comprises one of a data table on a client or an external database.

7. The method of claim 1, wherein the set of transformations comprises a physical transformation, a data space or distribution modification transformation, or a business problem transformation.

8. The method of claim 7, wherein the physical transformation comprises encoding data into a format accessible by the predictive algorithm.

9. The method of claim 7, wherein the data space transformation comprises a mathematical operation performed on numerical data.

10. The method of claim 7, wherein the data space transformation is automatically performed based on one or more requirements of the predictive algorithm.

11. The method of claim 10, wherein the one or more requirements of the predictive algorithm is based on non-acceptance or acceptance of numerical values.

12. The method of claim 10, wherein the one or more requirements of the predictive algorithm is based on non-acceptance or acceptance of categorical values.

13. The method of claim 7, wherein the business problem transformation comprises grouping data according to one or more objectives of the business problem.

14. The method of claim 1, wherein identifying the set of patterns comprises utilizing at least one of a neural network, logistic regression, linear regression, decision tree, naive Bayes classifier, Bayesian network, rule-based system, support vector machine, genetic algorithm, k-means clustering, expectation—maximization clustering, forecasting, and association rules.

15. The method of claim 1, wherein an identified pattern from among the identified set of patterns comprises a set of rules, a tree structure, a set of coefficients, a set of centroids, or a network structure.

16. The method of claim 1, wherein the associated predictive algorithm utilizes queries, parameters for the queries and one or more machine learning techniques for solving the business problem.

17. A computer-implemented method, the method comprising:
selecting a data source for a trained predictive model in which the trained predictive model includes a set of patterns, a set of transformations, and is associated with a predictive algorithm for solving a business problem;
applying the set of patterns according to the predictive algorithm to return a set of data from the data source;
performing the set of transformations on the set of data; and
providing a score indicating a probability of an event specified by the business problem based on the predictive algorithm on the set of data.

18. A computer-implemented method, the method comprising:
receiving a score corresponding to a predictive model for solving a business problem;
converting the score into a semantically meaningful format for an end-user; and
providing the converted score to the end-user.

19. The method of claim 18, wherein converting the score comprises assigning a set of labels to the score based on a set of conditions.

20. The method of claim 19, wherein the set of conditions comprises a cost function or a constraint specified by the business problem.

21. A system, the system comprising:
one or more processors;
a memory comprising instructions stored therein, which when executed by the one or more processors, cause the processors to perform operations comprising:
specifying a business problem to determine a probability of an event occurring in which the business problem includes a constraint;
selecting a data source for a predictive model associated with a predictive algorithm in which the predictive model includes one or more queries and parameters;
determining a set of transformations based on the queries and parameters for at least a subset of data from the data source to be processed by the predictive algorithm;
identifying a set of patterns based on the set of transformations for at least the subset of data from the data source; and
providing a trained predictive model including the determined set of patterns, the set of transformations, and the associated predictive algorithm for solving the specified business problem.

22. The system of claim 21, wherein the memory further comprises instructions stored therein, which when executed by the one or more processors, cause the processors to perform further operations comprising:
selecting a second data source for the trained predictive model;
applying the set of patterns according to the predictive algorithm to return a set of data from the second data source;
performing the set of transformations on the set of data; and
providing a score indicating a probability of an event specified by the business problem based on the predictive algorithm on the set of data.

23. The system of claim 21, wherein the memory further comprises instructions stored therein, which when executed by the one or more processors, cause the processors to perform further operations comprising:
receiving a score corresponding to the trained predictive model;
converting the score into a semantically meaningful format for an end-user; and
providing the converted score to the end-user.

24. A non-transitory machine-readable medium comprising instructions stored therein, which when executed by a machine, cause the machine to perform operations comprising:
specifying a business problem to determine a probability of an event occurring in which the business problem includes a constraint;
selecting a data source for a predictive model associated with a predictive algorithm in which the predictive model includes one or more queries and parameters;
determining a set of transformations based on the queries and parameters for at least a subset of data from the data source to be processed by the predictive algorithm;
identifying a set of patterns based on the set of transformations for at least the subset of data from the data source; and
providing a trained predictive model including the determined set of patterns, the set of transformations, and the associated predictive algorithm for solving the specified business problem.
